(19) United States
(12) Patent Application Publication
(10) Pub. No.: US 2005/0087719 A1
(43) Pub. Date: Apr. 28, 2005

(54) Magnetic nanodispersion with cyclodextrines and method for the production thereof

(76) Inventors: Christian Gansau, Nieder-Neuendorf (DE); Norbert Buske, Berlin (DE); Thomas Gotze, Berlin (DE)

Correspondence Address: A James Richardson;Brinks Hofer Gilson & Lione, Suite 1600, One Indiana Square, Indianapolis, IN, 46204, US

(21) Appl. No.: 10/493,954

(22) PCT Filed: Oct. 28, 2002
(86) PCT No.: PCT/EP02/12037

(30) Foreign Application Priority Data
Oct. 26, 2001 (DE) 101 54 016.7

(51) Int. Cl. H01F 1/00; B32B 5/16; B05D 5/12

(52) U.S. Cl. 252/62.56; 252/62.62; 252/62.51 R; 428/403; 427/128; 427/220; 427/221

(57) ABSTRACT

Substituted and non-substituted cyclodextrines are used as stabilizing agents for nanodispersions containing magnetic core particles M. The nanodispersions, which exhibit high saturation polarization with great biocompatibility, are suitable as transport vehicles for other pharmacologically and biologically active substances. The magnetic core particles of the nanodispersions are enveloped by compounds of the general formula (Aₚ, C, B_{q}), wherein A is reactive groups, B is bioactive groups and C is cyclodextrines.

The invention relates to a magnetic dispersion and process for its production according to the preambles of claims 1 and 15.

Magnetic dispersions are liquid stable dispersions having magnetic, in particular superparamagnetic properties.

They generally consist of three constituents:
a) a liquid dispersant, in which the magnetic core particles are stabilised and homogeneously distributed in the dispersion liquid,
b) core particles of ferrimagnetic or ferromagnetic material in the nano-size range. The core particles are composed of ferromagnetic or ferrimagnetic substances, such as magnetite, maghemite and mixtures thereof, and ferrites of the formula Me(II)O.Fe(III)₂O₃, wherein Me(II) is a metal ion, such as Co, Mn,
c) shells of non-magnetic molecules or polymers, which are chemically fixed to the particle surface of the core particles, wherein the adsorbents consist
   of fatty acids and derivatives thereof,
   of complex-forming fruit acids or
   of biologically degradable, water-soluble oligo-polymer molecules or derivatives thereof.

The complex-forming fruit acids and oligo molecules and polymer molecules do not reduce the surface tension of the dispersions, a prerequisite for biocompatibility.

Aqueous magnetic dispersions, the particles of which consist of a double layer of fatty acids and combinations of fatty acids with, for example non-ionic surfactants, such as ethoxylated fatty alcohols, but which are not biologically compatible, are also known.

In recent years, so-called biocompatible magnetic liquids have gained in particular importance. These include aqueous magnetic dispersions with nanoparticles which are surrounded by polysaccharides (U.S. Pat. No. 4,452,773, WO 91/02811, German Offenlegungsschrift 3 443 252).

Furthermore, magnetic nanoparticles are known which are stabilised by derivatives of polysaccharides, such as by polyaldehyde dextran (U.S. Pat. No. 6,231,982), aminodextran (WO 99/19731), carboxydextran (European 0 284 549).

In addition to polysaccharides, the family of dextrins are also mentioned in the publications, they are unambiguously dextrins with thread-like molecules having average molecular weights of 200 to 30,000, which, depending on the solvent, are more or less coiled. They are also known under the name “linear” dextrins.

α-cyclodextrins, β-cyclodextrins, and γ-cyclodextrins are described in detail, also as formers of inclusion compounds for small molecules (W. Saenger, Angew. Chem. 92, 343-361 (1980)). All are toxicologically harmless.

The cyclodextrins are ring-like oligosaccharides of (1-4) glucose units, which contain, for example six, seven or eight glucose units (up to 12 possible). They have very uniform molecular weights of 972, 1135 and 1297. α-cyclodextrins and γ-cyclodextrins have very good solubility in water.

A peculiarity is that these compounds form channel-like or cage-like supramolecular structures, that is 0.5-0.8 nm wide cavities, into which liquids and solids may be enclosed (nano-encapsulations).

Dispersions of magnetic nanoparticles which are surrounded by two polymer shell layers (German Patentschrift 4 428 851), which consist of an outer shell of a synthetic polymer and an outer shell of a target polymer, are also known. The layers may also have similar composition.

Linear oligosaccharides and polysaccharides are mentioned here, in particular dextran and also carboxymethyl dextrans.

German Offenlegungsschrift 19 624 426 also describes magnetic nanoparticles, which are stabilised in a dispersion liquid by crosslinked polysaccharides and derivatives thereof having molecular weights of 5,000-250,000.

According to WO 01/22088, the dextran shells are modified by means of iodate so that peptides (1-30 amino acids) are bound, which have, for example a defined affinity for the HIV virus.

European application 0 928 809, European application 0 525 199 describe the production of carboxymethyl dextran, carboxymethyl amminodextran and ether derivatives, wherein monochloroacetic acid is used as carboxylation agent. Magnetite volume percentages of 0 to 20 are claimed, which corresponds to a saturation polarisation up to 40 mT.

Core particle diameters of 5-50 nm, preferably of 6-15 nm, are mentioned.

The biocompatible magnetic liquids produced according to the state of the art have the following disadvantages:

Polysaccharides and derivatives thereof are thread molecules. They exist in a broad molecular weight range, predominantly having molecular weights above 20,000, which are then still only water-soluble to a limited extent. Their solubility is further considerably reduced in the presence of electrolytes. To stabilise magnetic nanoparticles in aqueous magnetic liquids, they are predominantly only suitable in adsorbed form in the acid pH range. Signs of coagulation already disadvantageously occur in the physiologically interesting pH ranges between 6.8-7.5. All said factors have a negative influence on the colloidal stability of the magnetic nanoparticles and hence also on the content of magnetic component or the saturation polarisation, which hardly exceeds 5 mT. Technical applications are thus as good as excluded.

It is the object of the invention to offer a magnetic dispersion which has high saturation polarisation with considerable biocompatibility, and its magnetic particles are suitable as a transport vehicle for further pharmacologically and biologically active substances, and to propose a process for its production.

The object is achieved according to the invention by the characterising parts of claims 1 and 15.

Advantageous developments are indicated in the sub-claims.

According to the invention, the novel magnetic dispersion consists of water or dispersants which can be mixed with water, in which the magnetic core particles are distributed finely and stably, wherein cyclodextrins and their derivatives according to the general formula M[Aₚ, C, B_{q}] are used as shell component. Here
M is magnetic core particles,
A is reactive groups,
B is bioactive groups and
C is cyclodextrins,
   consisting of
1,4-linked glucose units (C₆H₇O₅)ₘ[(3H)ₘ-(p+q)],
   wherein
m=6 to 12,
p is the number of A groups 1 to 3m and
q is the number of B groups 3m-p.

The compound (Aₚ, C, B_{q}) is fixed to the core particle surface via the reactive A group.

Cyclodextrins, the reactive A groups of which are —H or —(CH₂)ₙ—R and their salts, have been shown to be particularly advantageous with regard to achieving high stability for the magnetic dispersion and high saturation magnetisation, wherein n may assume the values from 0 to 20 and
R is —H, —(OH), —CHOH—CH₃, —(COOH), —(NH₂), —(SH), —(C₃N₃ClONa), —(OC₂H₄NH₂), —(NCH₃(CHO)), —(ONO₂), —(OSO₃H), —(OPO₃H₂), —(OCOC₆H₅), —(OCOR′), —(OCO(CH₂)ₙ—COOH), —(OCH₃), —(OCH₂CO₂Na), —(O(CH₂)ₙR′), —(OCH₂CHOHCH₂OH), —(O(CH₂CH₂O)ₙR′), —(O(CH₂)ₙSO₃H), wherein
R′ is —H, —(OH), —COOH), —(NH₂), —(SH), —(ONO₂), —(OSO₃H), —(OPO₃H₂).

In a further embodiment of the invention, the number q of bioactive B groups is 0. The required biocompatibility of the magnetic dispersion of the invention or the shell component cyclodextrin can already be achieved for certain applications without bioactive B groups. This is true particularly for applications in which the shell should have no specific or selective properties.

In a further embodiment of the invention, if the number q of bioactive groups is 0, only so many A groups are substituted as necessary for binding to the core particles M.

α-cyclodextrins, β-cyclodextrins and γ-cyclodextrins having a ring number of m=6, 7 or 8 glucose units are particularly advantageously suitable for further substitutions with reactive groups A and bioactive groups B.

The degree of substitution per glucose molecule thus lies between 0 and 3.

In a further embodiment of the invention, in particular compounds, such as streptavidin, insulin, heparin, nucleic acids, antibodies and enzymes are substituted on the cyclodextrin ring as bioactive groups B.

For certain selected areas of application, provision is made according to the invention in a further embodiment in that the cyclodextrins have only reactive groups A, that is, the bioactive groups B are replaced by A. This development according to the invention permits in particular carrying out of further chemical reactions.

In a further development according to the invention, conversely it is possible, instead of reactive groups A to substitute only bioactive groups B on the cyclodextrins or to modify reactive A groups, which project into the solution and are not fixed to the core particles M, by further coupling of chemical or biochemical compounds to form B groups.

A quite considerable advantage of the magnetic dispersion of the invention can be achieved in that a secondary structure can be built up around the shell which consists of several cyclodextrin molecules of the general formula [Aₚ, C, B_{q}]ₖ condensed in orderly manner, wherein k may assume values between 1 and 200. Due to this secondary structure being formed on a core particle, it is possible to provide cavities of different size, into which different substances may then be introduced and also desorbed again.

In a further advantageous embodiment of the invention, the cyclodextrins C are unsubstituted, wherein in particular α-cyclodextrins, β-cyclodextrins and γ-cyclodextrins having the defined molecular weights of 975, 1135 and 1297 are provided. The magnetic dispersions stabilised in this manner have the advantage that the magnetic core particles with this shell may pass into cancer cells without additional further treatments and thus magnetic marking becomes possible.

As is known, the magnetic core particles M are characterised in that they consist of maghemite and ferrites of the formula
Me(II)O.Fe(III)₂O₃, wherein
Me(II) is a metal ion, such as Fe, Co, Zn or Mn.

In a further embodiment of the invention, saturation polarisations between 0.05 and 80 mT can be set or achieved using the magnetic dispersions composed according to the invention for a size of the core particles M of 3 to 300 nm.

In particular the larger core particles can be better manipulated in a magnetic field and the dispersions having the larger particles have more advantageous viscosity properties.

Water, including physiological aqueous solutions, dimethylformamide, polyhydric alcohols, such as glycerin, ethylene glycol and polyethylene glycol or mixtures thereof are suitable as dispersants for the magnetic nanoparticles.

The production of the magnetic dispersions of the invention is effected by the following process steps
coprecipitation of iron(III) and metal(II) salts at a pH value in the alkaline range in a manner known per se,
washing using the dispersant and adjusting the pH value in the acid range in a manner known per se,
addition of a compound of the general formula (Aₚ, C, B_{q}) at temperatures between 20 and 90° C.,
wherein
A is reactive groups,
B is bioactive groups and
C is cyclodextrins consisting of
1,4-linked glucose units (C₆H₇O₅)ₘ[(3H)ₘ-(p+q)],
wherein
m=6 to 12,
p is the number of A groups 1 to 3m and
q is the number of B groups 3m-p,
washing reaction product using water and adjusting a pH value in a manner known per se,
dispersing the reaction product in a manner known per se at temperatures between 20 and 90° C., until a magnetic dispersion is produced.

It is expedient, after the first washing process, to set a pH value in the acid range, for example between 1 and 6. Depending on the intended application, it is also possible to add differently substituted cyclodextrans at temperatures between 20 and 90° C. Adding differently substituted cyclodextrans may also be effected in a two-stage process.

In a further embodiment of the invention, —H and/or —(CH₂)ₙ—R and their salts are provided as reactive A groups,

wherein

n may assume the values from 0 to 20 and
R is —H, —(OH), —CHOH—CH₃, —(COOH), —(NH₂), —(SH), —(C₃N₃ClONa), —(OC₂H₄NH₂), —(NCH₃(CHO)), —(ONO₂), —(OSO₃H), —(OPO₃H₂), —(OCOC₆H₅), —(OCOR′), —(OCO(CH₂)ₙ—COOH), —(OCH₃), —(OCH₂CO₂Na), —(O(CH₂)ₙR′), —(OCH₂CHOHCH₂OH), —(O(CH₂CH₂O)ₙR′), —(O(CH₂)ₙSO₃H), wherein R′ is —H, —(OH), —COOH), —(NH₂), —(SH), —(ONO₂), —(OSO₃H), —(OPO₃H₂),
and the B groups of which are, for example groups which are derived from avidins, such as streptavidin, such as insulin, heparin, nucleic acids, antibodies, oligopeptides, amino acid and enzymes.

In a further embodiment of the invention, a compound of the general formula (Aₚ, C) is used, the number of reactive A groups of which corresponds to the number of binding sites on the magnetic core particle M.

For a further embodiment of the process of the invention, a compound of the general formula (Aₚ, C) is reacted with the magnetic core particles M and then the complex M[Aₚ, C] formed is reacted with B_{q}.

In a development of the process of the invention, a cyclodextrin C is reacted with the magnetic core particle M, then the complex M[C] formed is reacted with a compound having reactive group Aₚ and then the complex M[Aₚ, C] formed is reacted with a compound having bioactive group B_{q} to form M[Aₚ, C, B_{q}].

In further embodiments of the process, mixtures of compounds of the general formula (Aₚ, C, B_{q}) are added, wherein in a particular embodiment, first of all a compound of the general formula (Aₚ, C, B_{q}) is added and then in a second step, a further compound of the general formula (Aₚ, C, B_{q}) is added.

In a further embodiment of the invention, before reacting with compounds having bioactive B groups, active esters, such as 1-ethyl-(3)-(3-diethylaminopropyl)carbodiimide, 1-cyclohexyl-3(2-morpholinoethyl)carbodiimide, N-hydroxy-succinimide and dicyclohexyl carbodiimide, are used.

In a further embodiment of the process of the invention, instead of the coprecipitation step, the hydroxide is precipitated from an Me(II) salt solution in a manner known per se and then treated with an oxidising agent, wherein divalent metal ions, such as Fe²⁺, Co²⁺, Zn²⁺ and Mn²⁺ represent Me(II). Hydrogen peroxide or oxygen in particular are thus used as oxidising agent. In particular magnetic dispersions, the core particles of which have a size of about 150 nm, may be produced by the thus modified process.

It is a considerable advantage that after dispersing, the magnetic dispersion may be treated with substrates X, so that these substrates X may be introduced into formed cavities in the shell of the magnetic nanoparticles, for example in the secondary structure which can be formed. Substrates X are understood to mean in particular compounds having pharmacological and/or biological activity. They are substances, such as antibiotics (penicillin), hormones (prostaglandins) or anti-tumour enzymes or anti-tumour proteins.

It has been found that aqueous dispersions of magnetic nanoparticles, which are stabilised by cyclodextrins and derivatives thereof, have high colloidal stability for the particles and an achievable volume proportion of magnetic component up to 20% or saturation polarisations of up to 80 mT. Furthermore, an improved biocompatibility is found. These novel properties are based firstly on the narrowly defined and low molecular weights of 972 to about 2,000 and the low shell layer thicknesses resulting therefrom and the better water solubility and on their stability in physiologically important pH ranges. Additional advantages with novel applications are produced from the cavities present in the particles, which can be used to accommodate and transport foreign materials. They may be desorbed specifically at the target site, a property which has considerable advantage when used as a “magnetic carrier”.

The magnetic dispersion of the invention, the dispersion medium of which consists either of water or liquids which can be mixed with water, wherein the shells of the magnetic core particles have biocompatible and/or chemoactive and/or bioactive properties, can be used diversely. The biocompatibility was tested in mixtures with biological cells with the result that none or no essential impairment of cell growth could be observed.

The magnetic dispersions of the invention may be used both technically and for biological/medical purposes.

For the technical applications, primarily the superparamagnetic volume properties are used, that is, the ability to move or even to fix the dispersion as a whole in the external magnetic field, such as for sealing purposes in magnetic liquid seals, for improving the performance of loudspeakers or for separating coloured metals or for enriching ore constituents for swim-sink sorting. The use is particularly appropriate if the biocompatibility of the particles may be used, for example in seals for rotary transmissions in the foodstuffs industry, for swim-sink sorting of biological objects, including cells of different density, of biotechnology or in medicine.

Magnetic dispersions having high values of saturation polarisation at low viscosities are preferably used. Furthermore, it is advantageous if the dispersion liquid consists of a solvent which is difficult to vaporise, for example of polyglycols or glycerin.

Saturation polarisations of about 80 mT are thus achieved. The clinical applications relate to their already known use as contrast agents for liver metastases by means of ferromagnetic resonance methods or for in vitro/in vivo coupling of bioactive molecules, such as nucleic acids. Magnetic liquid hyperthermy, in which cancer cells decorated specifically by magnetic particles are destroyed by overheating, is also known.

The novel magnetic liquids may be optimised for these applications, firstly by optimising the core particle size and secondly with regard to the hydrodynamic particle radius, which permits the production of particles having close particle size dimensions.

These optimisations are also significant in the optimisation of immunoassays by means of magnetic relaxometry.

It should be emphasised in particular that potentially novel areas of application are produced in that the adsorbed dextrins, in particular due to the formation of a secondary structure, have cavities, in which selectable liquid and also solid foreign materials, such as active ingredients, including pharmaceuticals, may be lodged. Hence, magnetic conductive transportable complexes can be produced, which are capable of diverse specific interactions, for example also with cells, including phagocytosis. The substances introduced can be desorbed at the action site, for example in or on a cell.

The invention is illustrated in more detail using drawings and exemplary embodiments.

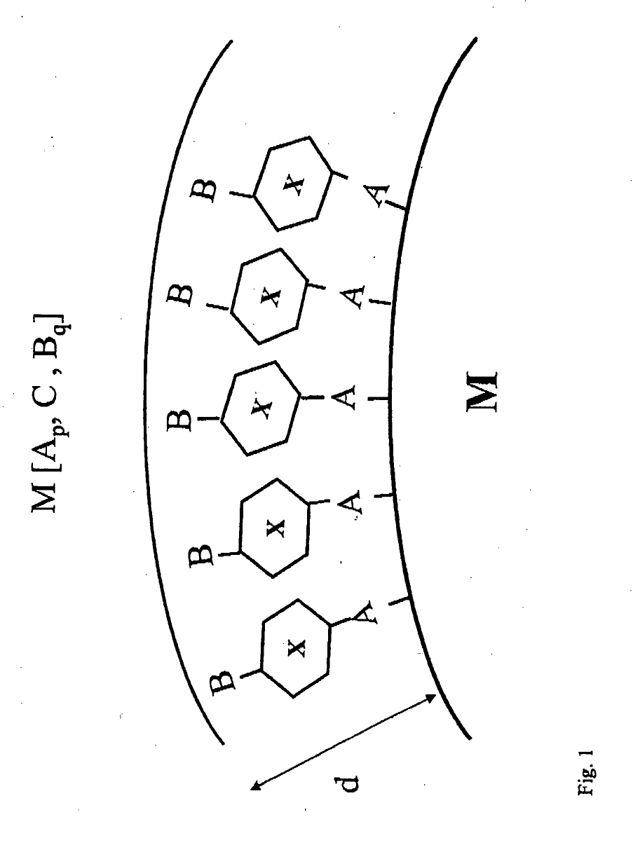

FIG. 1 shows a schematic representation of a possible structure of a magnetic nanoparticle,

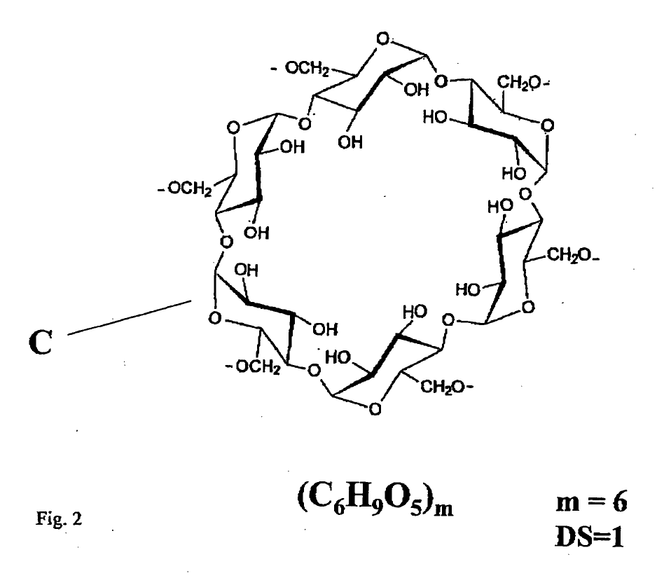

FIG. 2 shows a schematic representation of a substituted cyclodextrin molecule having 6 glucose units and a degree of substitution of DS=1,

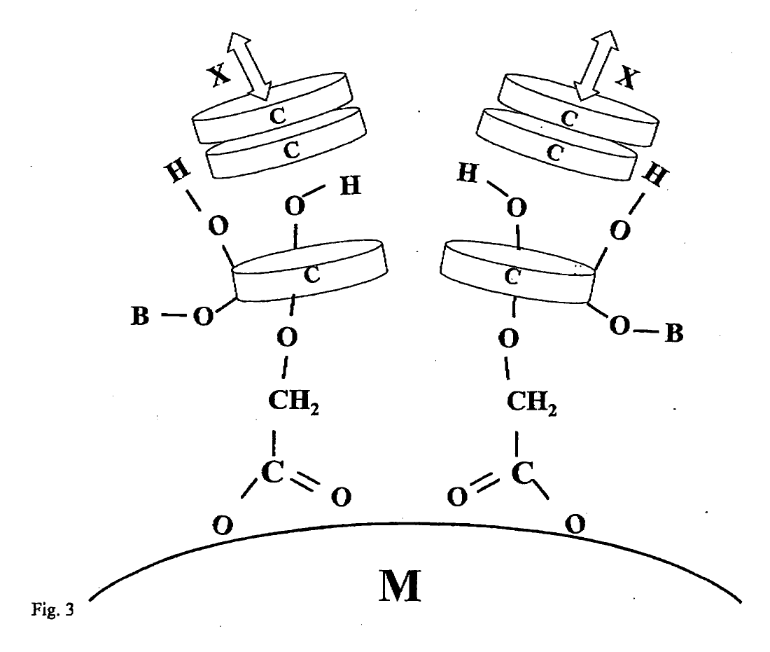

FIG. 3 shows a schematic representation of the formation of a possible secondary structure in the shell,

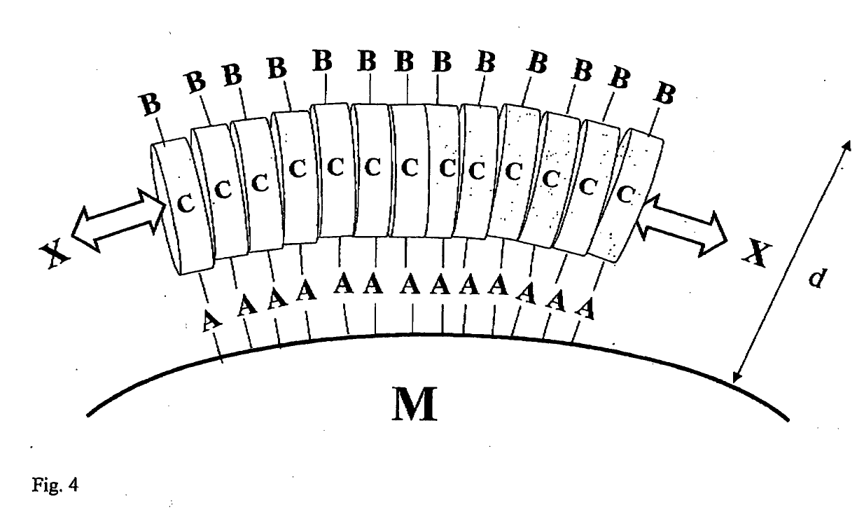

FIG. 4 shows a schematic representation of a possible secondary structure,

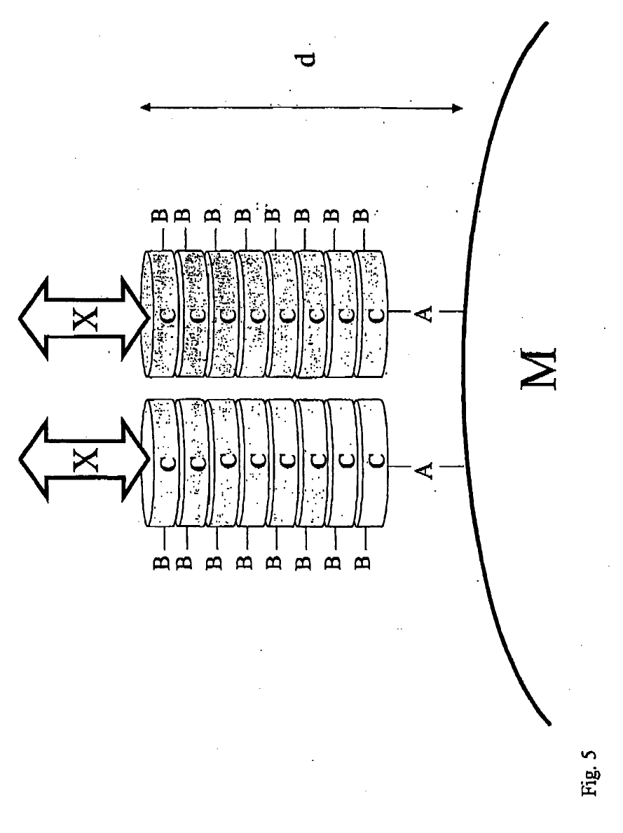

FIG. 5 shows a schematic representation of a further possible secondary structure of the shell,

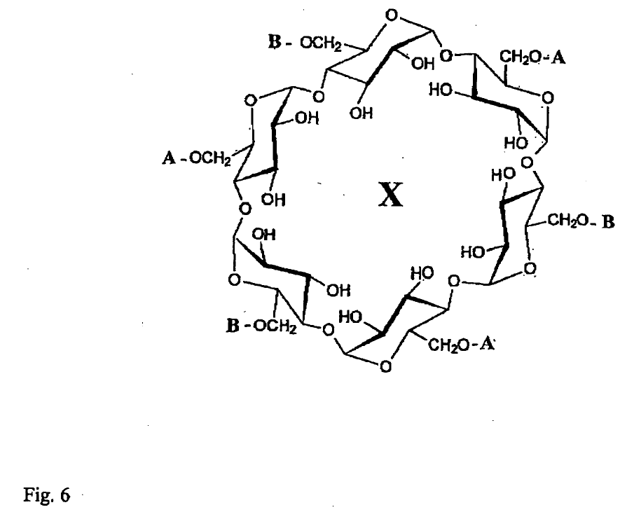

FIG. 6 shows a schematic representation of a cyclodextrin molecule having the groups A and B and a substance X,

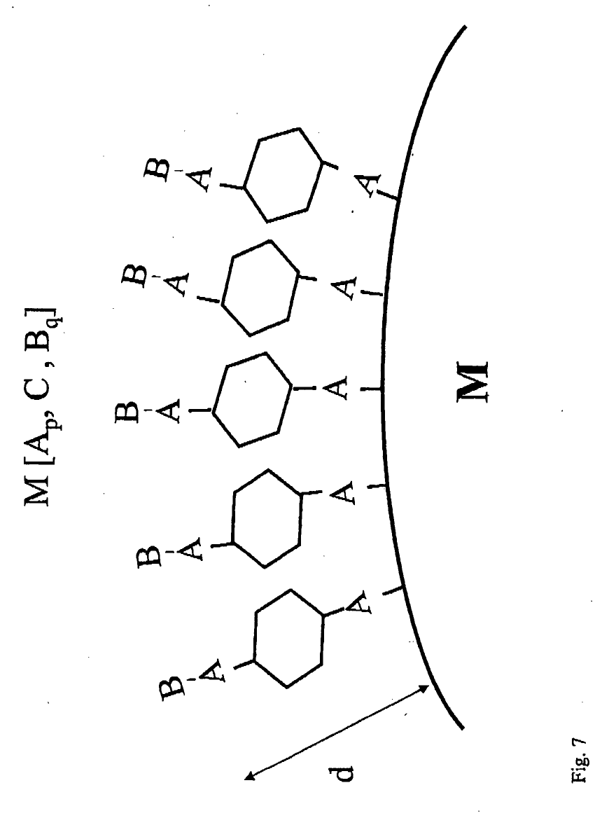

FIG. 7 shows a schematic representation of a substituted cyclodextrin molecule, which is bound to the magnetic core particle M via an A group, wherein the B groups are bound to the cyclodextrin ring via the reactive A groups and

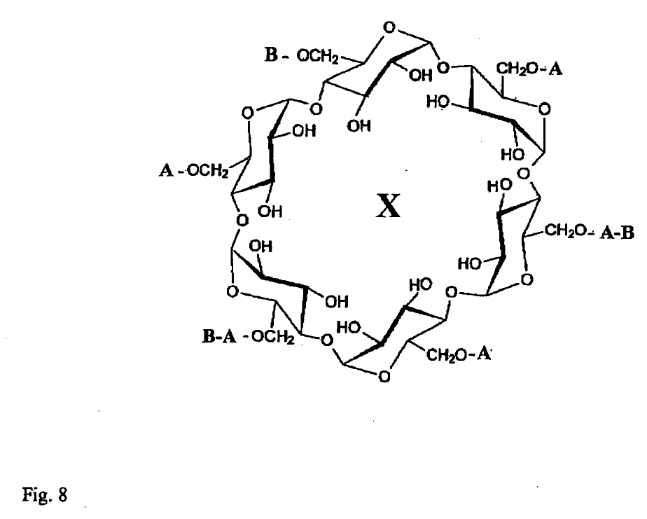

FIG. 8 shows a schematic representation of bound A or B groups.

The representation according to FIG. 1 shows schematically the structure of a magnetic nanoparticle. Around a magnetic core particle M, substituted cyclodextrins having a reactive group A are fixed to the surface of the core particle M, whereas bioactive groups B project into a dispersant not shown here. X symbolises the position of a substance in the cyclodextrin ring.

The cyclodextrin ring C shown in FIG. 2 shows that the reactive groups A or the bioactive groups B may be fixed to the groupings —OCH₂. The cyclodextrin ring has 6 glucose units, the degree of substitution is DS=1.

The representation according to FIG. 3 shows schematically the formation of a secondary structure. The cyclodextrin molecules are added on to one another with formation of a tunnel-like structure. A substance X can be introduced into this tunnel.

FIG. 4 shows the formation of a tunnel structure having the groupings A and B and the possibility of introducing a substance X.

FIG. 5 shows a further secondary structure, in which the tunnel-like condensations of the cyclodextrin molecules C having the bioactive groupings B and the reactive groups A effect fixing to the core particle M. The introduction of a substance X into the tunnel-like structures is also possible here.

FIG. 6 shows the groupings A and B in one possible constellation on a cyclodextrin molecule.

FIG. 7 shows the groups A and B in one possible constellation on a cyclodextrin molecule, which is bound to the surface of a magnetic core particle M.

FIG. 8 shows a further representation of the substitution sites on a cyclodextrin molecule, wherein the bioactive B groups may be bound to the molecule via a reactive A group or also directly.

The invention is illustrated in more detail using the following examples.

### EXAMPLE 1

Carboxymethylation of Cyclodextrins

10 g of α-cyclodextrin, β-cyclodextrin and γ-cyclodextrin are taken up in 200 ml of isopropanol, heated with stirring at 40° C. and treated with 6 g of NaOH, which is dissolved in 20 ml of water. 15 g of chloroacetic acid sodium salt, which is dissolved in 40 ml of water, are added to the mixture. The solution is heated at 70° C. and vigorously stirred for 90 minutes. After cooling to room temperature, the isopropanol phase is decanted off, the residue is adjusted to a pH value of 8 and the product is precipitated using 120 ml of methanol. The methanolic solution is decanted off and the carboxymethyl cyclodextrin sodium salt is dissolved in 100 ml of water, transferred into the acid through an ion exchanger (Dowex 50—strongly acidic), dialysed and the pure, crystalline carboxymethyl cyclodextrin having a degree of substitution of DS=0.6-1.0 carboxymethyl per glucose unit is obtained by freeze-drying.

### EXAMPLE 2

One-Pot Process

8.1 g of iron(III) chloride and 3.6 g of iron(II) chloride are dissolved together with 0.9 g of carboxymethyl α-cyclodextrin in 40 ml of water. About 18 ml of a 25% ammonia solution are added with stirring until a pH value of 9.5 is reached. The black precipitate is separated off magnetically and washed several times using water, taken up in 100 ml of water and adjusted to a pH value of 1-2 using concentrated hydrochloric acid. Stirring is then carried out for 30 minutes at 40° C. The particles formed are separated off using a magnet, washed several times using water, taken up in 20 ml of water and neutralised using 3 N sodium hydroxide solution. Dispersion is then carried out using ultrasound and an aqueous magnetic liquid is obtained in the neutral pH range with a saturation polarisation of 10 mT. This ML may be used for clinical purposes, or the free CM molecules may be further modified (bio)chemically.

### EXAMPLE 3

Production of Magnetite Particles Having 5 nm Diameter

27 g of iron(III) chloride and 12 g of iron(II) chloride are dissolved in 100 ml of water and treated with 60 ml of a 25% strength ammonia solution with stirring. The black precipitate is separated off magnetically and washed several times using water, taken up in 200 ml of water and adjusted to a pH value of 1-2 using concentrated hydrochloric acid and heated at 40° C. 3 g of carboxymethyl α-cyclodextrin, which are dissolved in 20 ml of water, are added dropwise to the magnetite sol formed and stirred for 30 minutes at 40° C. The particles formed are separated off using a magnet, washed several times using water, taken up in 100 ml of water and neutralised using 3 N sodium hydroxide solution. Dispersion is then carried out using ultrasound and a magnetic liquid with a saturation polarisation of 10 mT is obtained.

### EXAMPLE 4

Preparation of Magnetite Particles Having 8 nm Standard Diameter

8.1 g of iron(III) chloride are dissolved with 3.1 g of iron(II) chloride in 20 ml of water together with 0.4 g of α-cyclodextrin. 10 ml of a 28% strength saturated ammonia solution is added dropwise into this solution in 30 seconds. The black precipitate is washed several times using water up to a conductivity of 5 mS/cm and a pH value of 8 and separated by means of a permanent magnet. The addition of 20% strength aqueous hydrochloric acid solution then takes place until a pH value of 2 is reached. The solution is stirred moderately at room temperature for 1 hour. The particles are then separated magnetically, taken up in 20 ml of water and dispersed using ultrasound. The stable magnetic liquid has a saturation polarisation of about 15 mT.

### EXAMPLE 5

Having 10 nm Diameter

13.5 g of iron(III) chloride and 6 g of iron(II) chloride are dissolved in 200 ml of water and treated with 100 ml of an 8% strength ammonia solution with stirring. The black precipitate is separated off magnetically and washed several times using water, taken up in 150 ml of water and adjusted to a pH value of 1-2 using concentrated hydrochloric acid and heated at 40° C. 1.5 g of carboxymethyl β-cyclodextrin, which are dissolved in 20 ml of water, are added dropwise to the magnetite sol formed and stirred for 30 minutes at 40° C. The particles formed are separated off using a magnet, washed several times using water, taken up in 40 ml of water and neutralised using 3 N sodium hydroxide solution. Dispersion is then carried out using ultrasound and the dispersion is concentrated on a rotary evaporator. 10 ml of a magnetic liquid having a saturation polarisation of 40 mT are obtained. The ML is also suitable for technical use.

### EXAMPLE 6

8.1 g of iron(III) chloride and 3.6 g of iron(II) chloride are dissolved together with 0.9 g of γ-cyclodextrin in 40 ml of water. About 50 ml of a 3 N sodium hydroxide solution are added with stirring until a pH value of 11 is reached. The black precipitate is separated off magnetically and washed several times using water, taken up in 100 ml of water and adjusted to a pH value of 1-2 using concentrated hydrochloric acid. Stirring is then carried out for 30 minutes at 40° C. The particles formed are separated off using a magnet, washed several times using water, taken up in 30 ml of water and neutralised using 3 N sodium hydroxide solution. Dispersion is then carried out using ultrasound and a magnetic liquid having a saturation polarisation of 6 mT is obtained.

### EXAMPLE 7

8.1 g of iron(III) chloride and 3.6 g of iron(II) chloride are dissolved in 40 ml of water and treated with 18 ml of a 25% strength ammonia solution with stirring. The black precipitate is separated off magnetically and washed several times using water, taken up in 100 ml of water and adjusted to a pH value of 1-2 using concentrated hydrochloric acid and heated at 40° C. 0.5 g of carboxymethyl α-cyclodextrin and 0.5 g of carboxymethyl β-cyclodextrin, which are dissolved in 20 ml of water, are added dropwise to the magnetite sol formed and the mixture is stirred for 30 minutes at 40° C. The particles formed are separated off using a magnet, washed several times using water, taken up in 20 ml of water and neutralised using 3 N sodium hydroxide solution. Dispersion is then carried out using ultrasound and 20 ml of a magnetic liquid having a saturation polarisation of 10 mT are obtained.

### EXAMPLE 8

The magnetisable particles prepared according to Example 2 are taken up using 100 ml of ethylene glycol after separating off the water. The small quantities of water still present in the solution are removed using a rotary evaporator. The magnetic liquid has a saturation polarisation of 30 mT. It may be used technically in rotary transmissions.

### EXAMPLE 9

Preparation of a magnetofluid according to Example 5 with the difference that the magnetically separated particles are taken up in 30 ml of dimethylformamide. The stable magnetic liquid contains up to 10% of water in the dimethylformamide and has a saturation polarisation of 6 mT.

### EXAMPLE 10

Process for covalent coupling to the particles produced in Example 1 (one-pot process), by reacting 2 ml of magnetic liquid ( . . . mg/ml) with an aqueous solution of 10 mg of 1-ethyl-3-(dimethylaminopropyl)carbodiimide (EDC) in 2 ml of 0.1 2-morpholinoethane sulphonic acid monohydrate (MES) buffer in the presence of 10 mM of N-hydroxysuccinimide with stirring and at room temperature. The addition of 2 mg of streptomycin then takes place. The reactants are reacted for 5 hours with constant stirring and at room temperature. The stable magnetofluid is diluted using 20 ml of water and has a saturation polarisation of 5 mT.

### EXAMPLE 11

Production of covalently bound biologically active substances according to Example 9 with the difference that in a two-stage process after the reaction of EDC and the magnetic liquid is washed twice using a 10 ml 0.1 MES buffer.

### EXAMPLE 12

Covalent coupling according to Example 9, wherein in addition to the 1-ethyl-3-(-(dimethylaminopropyl)carbodiimide, 10 mM of hydroxysuccinimide are also added to the magnetic liquid and the reaction leads to covalent binding of the biologically active substance via the formation of the so-called active ester, the carboxymethyl cyclodextrin ester.

### EXAMPLE 13

Preparation of particles with covalent coupling of streptomycin according to Examples 9-11, starting from the production of magnetisable particles, the average particle diameter of which is 10 nm, described in Example 4. The stable magnetic liquids have a saturation polarisation of 10 mT after dilution.

### EXAMPLE 14

Preparation of core particles having a diameter of 10 nm according to Example 4 by taking up the particles in 50 ml of water and adjusting the pH value to 4 using dilute hydrochloric acid. The addition of 1.5 g of testosterone hydroxypropyl-α-cyclodextrin (CTD.Inc) containing 100 mg of active ingredient for 1 g of β-cyclodextrin, takes place with stirring. The solution is stirred moderately for one hour at 35° C. The particles are then separated off using a magnet, washed several times using water, taken up in 50 ml of water and neutralised using a few drops of 3 N sodium hydroxide solution. Dispersion is then carried out using ultrasound. A biologically compatible magnetic liquid having a saturation polarisation of 10 mT is obtained which may be used for improved local administration of testosterone in the human body.

### EXAMPLE 15

Long-Term Stability Test:

The CM cyclodextrin magnetic liquid produced in Example 2 and an analogously prepared magnetic liquid with carboxymethyl dextran as shell component were treated as follows for long-term studies: In each case 4 ml of ML were placed in Fiolax test tubes, closed with a stopper and stored at 4° C. The saturation polarisation and the particle uptake in cell cultures was measured at the start of the test and after 10 weeks. In the CM dextran sample, after the end of the test there was agglomeration and sedimentation in the small sample tubes and the saturation polarisation of the solution dropped by 40%. The particle uptake in cell cultures decreased by 50%. In the CM cyclodextrin sample, from the start of the test to the end of the test there were no noticeable changes.

### EXAMPLE 16

5.4 g of iron(III) chloride are dissolved with 1.3 g of cobalt(II) chloride in 20 ml of water. 25 ml of a 25% strength tetramethyl ammonium hydroxide solution are added dropwise into this solution in 30 seconds. The black precipitate is washed several times using water up to a conductivity of 10 mS/cm and a pH value of 8 and separated by means of a permanent magnet. A pH value of 2.5 is then set in the aqueous solution by addition of 20% strength aqueous hydrochloric acid solution. After adding 0.2 g of α-cyclodextrin, the solution is stirred moderately at room temperature for 1 hour. The particles are then separated magnetically, taken up in 20 ml of water and dispersed using ultrasound. The stable magnetic liquid has a saturation polarisation of about 10 mT and has an above-averagely high value of magnetic susceptibility. These magnetofluids are particularly suitable for use in magnetic relaxometry and hyperthermy.

### EXAMPLE 17

Dispersion with 150 nm Magnetite Particles

20 g of iron(II) chloride are dissolved in 300 ml of water, heated at 70° C. and treated with 40 ml of a 6 molar potassium hydroxide solution with stirring.

9.7 ml of a 10% hydrogen peroxide (H₂O₂) solution are then slowly added dropwise and stirred for 40 minutes at 70-75° C. The precipitate is separated off magnetically and washed several times using water, taken up in 200 ml of water and adjusted to a pH value of 1.5-2 using concentrated hydrochloric acid and heated at 50° C. 1.5 g of carboxymethyl β-cyclodextrin, which are dissolved in 20 ml of water, are added to the mixture and stirred for 30 minutes at 50° C.

The particles formed are separated off using a magnet, washed several times using water, taken up in 40 ml of water, neutralised using 3 molar sodium hydroxide solution and dispersed using ultrasound. The dispersion formed contains magnetite particles having a core particle size of 100-150 nm.

1. Magnetic dispersion based on water, or dispersants which can be mixed with water, and magnetic nanoparticles dispersed and stabilised therein, wherein the magnetic nanoparticles consist essentially of magnetic core particles and a shell of the general formula
M[Aₚ, C, B_{q}]
wherein
M is magnetic core particles,
A is reactive groups,
B is bioactive groups and
C is cyclodextrines,
consisting of
1,4-linked glucose units (C₆H₇O₅)ₘ[(3H)ₘ-(p+q)],
wherein
m=6 to 12,
p is the number of A groups 1 to 3m and
q is the number of B groups 3m-p.

2. Magnetic dispersion according to claim 1, wherein the reactive A groups are —H and/or —(CH₂)ₙ—R and their salts,
wherein
n may assume the values from 0 to 20 and
R is —H, —(OH), —CHOH—CH₃, —(COOH), —(NH₂), —(SH), —(C₃N₃ClONa), —(OC₂H₄NH₂), —(NCH₃(CHO)), —(ONO₂), —(OSO₃H), —(OPO₃H₂), —(COC₆H₅), —(OCOR′), —(OCO(CH₂)ₙ—COOH), —(OCH₃), —(OCH₂CO₂Na), —(O(CH₂)ₙR′), —(OCH₂CHOHCH₂OH), —(O(CH₂CH₂O)ₙR′), —(O(CH₂)ₙSO₃H), wherein R′ is —H, —(OH), —(COOH), —(NH₂), —(SH), —(ONO₂), —(OSO₃H), —(OPO₃H₂).

3. Magnetic dispersion according to claim 1 or 2, wherein the number q of bioactive B groups is zero.

4. Magnetic dispersion according to claim 3, wherein only so many A groups are substituted as are necessary for binding to the core particles M.

5. Magnetic dispersion according to claim 4, wherein the degree of substitution is between 0 and 3 per glucose molecule.

6. Magnetic dispersion according to claim 1 or 2, wherein the bioactive B groups are derived from one or more of avidins, insulin, heparin, nucleic acids, antibodies, oligopeptides, amino acid and enzymes.

7. Magnetic dispersion according to claim 1 or 2, wherein the reactive B groups correspond to those of reactive A groups.

8. Magnetic dispersion according to claim 7, wherein the A groups, which project into the solution and are not fixed to the core particles M, are modified by coupling chemical or biochemical compounds to form bioactive B groups.

9. Magnetic dispersion according to claim 1 or 2 wherein the shell has a secondary structure consisting essentially of several cyclodextrin molecules of the general formula [Aₚ, C, B_{q}]ₖ condensed in orderly manner, wherein k may assume values between 1 and 200.

10. Magnetic dispersion according to claim 1 or 2 wherein C is unsubstituted and consists essentially of α-cyclodextrines, β-cyclodextrines and γ-cyclodextrines having the defined molecular weights of 975, 1135 and 1297.

11. Magnetic dispersion according to claim 1 or 2 wherein the core particles M consist essentially of maghemite and ferrites of the formula Me(II)O Fe(III)₂O₃, wherein Me(II) is a metal ion, such as Fe, Co, Zn or Mn.

12. Magnetic dispersion according to claim 1 or 2 wherein the size of the core particles M is between 3 and 300 nm.

13. Magnetic dispersion according to claim 1 or 2 wherein the magnetic dispersion has a saturation polarization of 0.05 to 80 mT.

14. Magnetic dispersion according to claim 1 or 2 wherein the dispersants are physiological aqueous solutions, dimethylformamide, polyhydric alcohols, glycerin, ethylene glycol and polyethylene glycol or mixtures thereof.

15. Process for producing magnetic dispersions according to claim 1, comprising the steps of:
co-precipitating iron (III) and metal (II) salts at a pH value in the alkaline range,
washing using a dispersant and adjusting the pH value in the acid range,
adding a compound of the general formula (Aₚ, C, B_{q}) at temperatures between 20 and 90° C.,
wherein
A is reactive groups,
B is bioactive groups and
C is cyclodextrines,
consisting of
1,4-linked glucose units (C₆H₇O₅)ₘ[(3H)ₘ-(p+q)],
wherein
m=6 to 12,
p is the number of A groups 1 to 3m and
q is the number of B groups 3m-p, to form a reaction product,
washing the reaction product using water, and
dispersing the reaction product at temperatures between 20 and 90° C., until a magnetic dispersion is produced.

16. Process according to claim 15, further comprising the step of using compounds of the general formula (Aₚ, C, B_{q}), the A groups of which are —H and/or —(CH₂)ₙ—R and their salts,
wherein
n may assume the values from 0 to 20 and
R is —H, (OH), —CHOH—CH₃, —(COOH), —(NH₂), —(SH), —(C₃N₃ClONa), —(OC₂H₄NH₂), —(NCH₃(CHO)), —(ONO₂), —(OSO₃H), —(OPO₃H²), —(OCOC6H5), —(OCOR′), —(OCO(CH₂)ₙ—COOH), —(OCH₃), —(OCH₂CO₂Na), —(O(CH₂)ₙR′), —(OCH₂CHOHCH₂OH), —(O(CH₂CH₂O)ₙR′), —(O(CH₂)ₙSO₃H),
wherein
R′ is —H, —(OH), —(COOH), —(NH₂), —(SH), —(ONO₂), —(OSO₃H), —(OPO₃H₂),
and the B groups are derived from at least one of avidins, streptavidin, insulin, heparin, nucleic acids, antibodies, oligopeptides, amino acid and enzymes.

17. Process according to claim 15 further comprising the step of using a compound of the general formula (Aₚ, C), the number of reactive A groups of which corresponds to the number of binding sites on the magnetic core particle M.

18. Process according to claim 17, further comprising the step of reacting the compound of the general formula (Aₚ, C) with the magnetic core particles M to form a complex, and then reacting the complex M[Aₚ, C] with B_{q}.

19. Process according to claim 15 further comprising the step of reacting a cyclodextrin C with the magnetic core particle M to form a complex, then reacting the complex M[C] with a compound having reactive group A to form a second complex, and finally reacting the second complex M[Aₚ, C] with a compound having bioactive group B_{q} to form M[Aₚ, C, B_{q}].

20. Process according to claim 15 or 16, further comprising the step of setting the pH value, after the first washing process, at a pH value between 1 and 6.

21. Process according to claim 15 or 16, wherein said adding step comprises adding a mixture of compounds of the general formulae (Aₚ, C, B_{q}).

22. Process according to claim 15 or 16, wherein said adding step comprises the steps of adding a first compound of the general formula (Aₚ, C, B_{q}) and in a second step, adding a further compound of the general formula (Aₚ, C, B_{q}).

23. Process according to claim 15 or 16, further comprising the step of using for the bioactive group B an active ester selected from 1-ethyl-(3)-(3-diethylaminopropyl)carbodiimide, 1-cyclohexyl-3(2-morpholinoethyl)carbodiimide, N-hydroxysuccinimide and dicyclohexyl carbodiimide.

24. Process for producing magnetic dispersions according to claim 1, comprising the steps of:
precipitating a hydroxide from a Me(II) salt solution, wherein Me(II) is a divalent metal ion selected from Fe²⁺, Co²⁺, Zn²⁺ and Mn²⁺,
treating the hydroxide precipitate with an oxidizing agent,
washing the treated precipitate using a dispersant and adjusting the pH value in the acid range,
adding a compound of the general formula (Aₚ, C, B_{g}) at temperatures between 20 and 90° C.,
wherein
A is reactive groups.
B is bioactive groups and
C is cyclodextrines.
consisting of
1.4-linked glucose units (C₆H₇O₅)ₘ[(3H)ₘ-(p+q)],
wherein
m=6 to 12,
p is the number of A groups 1 to 3m and
q is the number of B groups 3m-p, to form a reaction product.
washing the reaction product using water, and
dispersing the reaction product at temperatures between 20 and 90° C. until a magnetic dispersion is produced.

25. Process according to claim 24 wherein the treating step comprises using an oxidizing agent selected from hydrogen peroxide or oxygen.

26. Process for producing magnetic dispersions according to claims 15 or 24, further comprising the step of treating the reaction product with a compound having pharmacological and/or biological activity.

27. Process according to claim 26, wherein the treating step further comprises selecting a compound from antibodies, hormones anti-tumour enzymes or anti-tumour proteins.

28. Use of substituted and non-substituted cyclodextrines as stabilising agents for dispersions containing magnetic core particles M.

29. Process according to claim 24, further comprising the step of using compounds of the general formula (Aₚ, C, B_{q}), the A groups of which are —H and/or —(CH₂)ₙ—R and their salts,
wherein
n may assume the values from 0 to 20 and
R is —H, (OH), —CHOH—CH₃, —(COOH), —(NH₂), —(SH), —(C₃N₃ClONa), —(OC₂H₄N H₂), —(NCH₃(CHO)), —(ONO₂), —(OSO₃H), —(OPO₃H²), —(OCOC6H5), —(OCOR′), —(OCO(CH₂)ₙ—COOH), —(OCH₃), —(OCH₂CO₂Na), —(O(CH₂)ₙR′), —(OCH₂CHOHCH₂OH), —(O(CH₂CH₂O)ₙR′), —(O(CH₂)ₙSO₃H),
wherein
R′ is —H, —(OH), —(COOH), —(NH₂), —(SH), —(ONO₂), —(OSO₃H), —(OPO₃H₂),
and the B groups are derived from at least one of avidins, streptavidin, insulin, heparin, nucleic acids, antibodies, oligopeptides, amino acid and enzymes.

30. Process according to claim 24 further comprising the step of using a compound of the general formula (Aₚ, C), the number of reactive A groups of which corresponds to the number of binding sites on the magnetic core particle M.

31. Process according to claim 30, further comprising the step of reacting the compound of the general formula (Aₚ, C) with the magnetic core particles M to form a complex, and then reacting the complex M[Aₚ, C] with B_{q}.

32. Process according to claim 24 further comprising the step of reacting a cyclodextrin C with the magnetic core particle M to form a complex, then reacting the complex M[C] with a compound having reactive group A to form a second complex, and finally reacting the second complex M[Aₚ, C] with a compound having bioactive group B_{q} to form M[Aₚ, C, B_{q}].

33. Process according to claim 24 or 29 further comprising the step of setting the pH value, after the first washing process, at a pH value between 1 and 6.

34. Process according to claim 24 or 29 wherein said adding step comprises adding a mixture of compounds of the general formulae (Aₚ, C, B_{q}).

35. Process according to claim 24 or 29 wherein said adding step comprises the steps of adding a first compound of the general formula (Aₚ, C, B_{q}) and in a second step, adding a further compound of the general formula (Aₚ, C, B_{q}).

36. Process according to claim 24 or 29 further comprising the step of using for the bioactive group B an active ester selected from 1-ethyl-(3)-(3-diethylaminopropyl)carbodiimide, 1-cyclohexyl-3(2-morpholinoethyl)carbodiimide, N-hydroxysuccinimide and dicyclohexyl carbodiimide.
